(19) United States
(12) Patent Application Publication
(10) Pub. No.: US 2022/0137799 A1
(43) Pub. Date: May 5, 2022

(54) System and method for content driven design generation

(71) Applicant: Canva Pty Ltd, Surry Hills (AU)

(72) Inventors: Denis Chashchin, Cammeray (AU); Reynaldo Lázaro Aguilar Casajuana, Carlton (AU); Yu Su, Gordon (AU); Paul Karl Knittel, Bond (AU); Elijah Alexander Sheppard, Coogee (AU)

(21) Appl. No.: 17/515,364

(22) Filed: Oct. 29, 2021

(30) Foreign Application Priority Data
Oct. 30, 2020 (AU) 2020260557
Oct. 30, 2020 (AU) 2020260558

(51) Int. Cl. G06F 3/0484; G06F 3/0482

(52) U.S. Cl. CPC G06F 3/04845; G06F 3/0482

(57) ABSTRACT

Described herein is a computer implemented. The method includes detecting a user input selecting a particular media item. In response, one or more template bundles are selected and one or more designs are generated, each design corresponding to a template bundle. Generating a particular design corresponding to a particular template bundle includes rendering template bundle media items corresponding to the non-placeholder element in the template bundle, and, for each placeholder element defined by the template bundle, rendering a user selected media item. The one or more designs are then displayed.

### CROSS-REFERENCE TO RELATED APPLICATIONS

This application is a U.S. Non-Provisional application that claims priority to Australian Patent Application No. 2020260557, filed Oct. 30, 2020, and to Australian Patent Application No. 2020260558, filed Oct. 30, 2020, which are hereby incorporated by reference in their entirety.

### FIELD

The present disclosure is directed to systems and methods for content driven design generation.

### BACKGROUND

Applications exist which provide functionality for creating and publishing designs.

Typically, such applications provide a mechanism for users to create new designs using design templates. A user can select an existing design template and edit it as desired to create a final design—e.g. by adding/deleting/editing design elements. Design templates are convenient because they provide a design starting point but at the same time provide flexibility for users to customise as desired.

At the same time, however, template-based design generation can be both a computer processor intensive process and/or require significant user input. This is particularly the case, for example, if a user wishes to experiment and see how designs that include various user-selected media items (such as photos or videos) would look if generated based on different templates. Rendering templates can be processor intensive (which can cause frustrating delays for the user), and preparing each separate template to include the desired media items can require substantial user input (which can also be frustrating).

Background information described in this specification is background information known to the inventors. Reference to this information as background information is not an acknowledgment or suggestion that this background information is prior art or is common general knowledge to a person of ordinary skill in the art.

### SUMMARY

Described herein is a computer implemented method including: detecting an item selection user input, the item selection user input selecting a particular media item; in response to detecting the item selection user input: selecting one or more template bundles, each template bundle including: a template bundle descriptor defining one or more non-placeholder elements and one or more placeholder elements; and one or more template bundle media items, each template bundle media item corresponding to a non-placeholder element defined by the template bundle descriptor; generating a plurality of designs, each design corresponding to a template bundle, wherein generating a particular design corresponding to a particular template bundle includes: for each non-placeholder element defined by the template bundle descriptor of the particular template bundle, rendering the template bundle media item corresponding to the non-placeholder element; and for each placeholder element defined by the template bundle descriptor of the particular template bundle, rendering a user selected media item, at least one of the user selected media items rendered being the particular media item; and displaying at least one of the one or more designs.

### BRIEF DESCRIPTION OF THE DRAWINGS

In the drawings:

FIG. 1 is a block diagram illustrating an example environment in which features of the present disclosure can be implemented.

FIG. 2 is an example computer processing system configurable to perform various features described herein.

FIG. 3 is a flowchart depicting operations performed to generate a pre-rendered template bundle.

FIG. 4 is a flowchart depicting operations performed to generate a pre-rendered template bundle media item corresponding to a single element defined by a complete design template.

FIG. 5 is a flowchart depicting operations performed to generate a pre-rendered template bundle media item corresponding to a group of elements defined by a complete design template.

FIG. 6 is a flowchart depicting operations performed to generate a design using a pre-rendered template bundle.

FIG. 7 is an example user interface for content-driven design generation.

FIG. 8 is an example user interface for content-driven design generation.

FIG. 9 is an example user interface for content-driven design generation.

FIG. 10 is an example user interface for content-driven design generation.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the spirit and scope of the present invention as defined by the appended claims.

### DETAILED DESCRIPTION

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

As described above, design applications which allow users to create a design by choosing a design template and then editing that template to create a final design exist.

The present disclosure provides mechanisms for content-driven design creation. Generally speaking, this involves a user generating designs by the selection of media items (e.g. photos, videos, or other media items). The selected media items are then used to generate multiple designs, each design being based on a pre-rendered template bundle. The generated designs are then displayed, which allows a user to preview multiple designs by selecting media items.

This is in contrast with a process where in order to generate/preview a single design the user must initially select a template, have the template rendered as a design (including placeholder elements), select one or more media items to replace/be held by the placeholder elements, preview the design. This process is then repeated for any other templates the user may wish to preview with the selected media item(s).

Furthermore, the manner in which the pre-rendered template bundles as described herein are generated and displayed allows for designs based on those template bundles to be efficiently rendered. This, in turn, allows multiple designs based on different pre-rendered template bundles to be quickly rendered and displayed for a user to view.

As used herein, the term ‘design’ refers to a visual or graphic design.

For the purposes of the present description, a design may include, or be associated with, design metadata and one or more design elements.

Design metadata includes data describing various design attributes. Such attributes may include, for example, a design identifier, canvas size/dimensions (e.g. height and width), a design type, a design author, and/or other design attributes.

Design elements are items that make up a design—for example photographs, renderings, drawings, text, and/or other graphic items. In the present disclosure, a given design element is associated with element metadata and element media.

Element metadata describes various attributes of a given design element. Attributes of a design element may include, for example: an element type (for example whether the element is a shape, text, raster image, vector graphic, video, audio, or an alternative type); an element position (e.g. x/y coordinates of where a defined point the element (such as the top left corner) is positioned on the design canvas); the size of the element (e.g. width and height); any rotation of the element; any scaling of the element; any flipping of the element (on the x- and/or y-axis); any opacity applied to the element; any colour or other filters applied to the element; an element animation (defining, for example, the way an element appears/disappears/moves); whether the element is a placeholder-type element (i.e. an element that is intended to be replaced by a user selected media item); the depth of the element relative to other elements (which, as described below, may be implicitly rather than explicitly defined); whether the element is a member of a particular element group (which, as described below, may be implicitly rather than explicitly defined). Element metadata may also include an element type which may, in turn, define what other attributes are relevant to/available to be defined for the element in question.

Element media is the specific media item of the design element—e.g. a photo, graphic, video, audio file, or other media item. For the purposes of the present disclosure, design elements are described as being vector elements, raster elements, or other elements.

Vector elements are elements whose media is described in a vector graphic format (e.g. SVG or an alternative vector graphic format). Such elements can include lines, geometric shapes, text, freehand drawings, and other vector graphic components.

Raster elements are elements whose media is described in a raster format (e.g. the JPEG, GIF, animated GIF, PNG, or other raster format). Such elements can include photos, drawings, and/or other images.

Other elements are elements with media items that are neither vector format nor raster format (e.g. video, audio).

In the present disclosure, a given design element may also be defined as a placeholder element: i.e. an element included in a design template (discussed below) that is intended to be replaced by a user selected media item (e.g. a photo or other media item). By way of example, a design template may define a rectangular placeholder element (e.g. a placeholder photo/graphic) of a defined size, at a defined x/y position on the canvas, and at a particular depth. When the template is used to generate a design the intention is for the rectangular element to define the position and shape of (and be replaced by) a user selected media item.

An element may be designated as a placeholder element in various ways. For example, a dedicated placeholder attribute may be provided which can take either a value indicating the element is a placeholder (e.g. ‘T’ or 1) or a value indicating the element is not a placeholder (e.g. ‘F’ or 0).

A design creation application will typically provide various tools for editing designs and design elements. For example, editing operations that may be available for most element types include: positioning/moving an element on a design canvas (e.g. in the horizontal and vertical dimensions); bringing an element forward (or to the top)/sending an element back (or to the bottom) to adjust an element's depth relative to other elements; re-sizing an element; rotating an element; flipping an element in an x- and/or y-direction; making an element transparent; recolouring an element (e.g. via a filter); adding/removing an element from an element group.

For vector elements, additional operations may be available that allow the components of the element's vector graphic to be edited. For example, to: change fill and/or stroke colour or style; add/delete/amend paths or shapes; change font style or type (for text).

In the present disclosure, a design is defined by a design descriptor. For a given design, the design descriptor includes the design metadata and element descriptors for each element of the design. For a given element, the element descriptor includes element metadata and may either define the element media (e.g. in-line) or include a reference to the design element media. For example, element descriptors for raster elements, other elements (e.g. non-vector and non-raster elements) and complex vector elements will typically provide a reference to a media file (e.g. a URL, file location, or other reference). These media items may be referred to as referenced media items. For simple vector elements (e.g. basic geometric shapes and the like), however, the media may be defined in-line in the element descriptor itself (e.g. by defining path parameters and the like in the relevant vector graphic format). These may be referred to as in-line media items.

Any appropriate format for design descriptors (and element descriptors) may be used. In the described embodiments, design descriptors are provided in a device independent format. Specifically, in the described embodiments design descriptors are provided in a JSON format file in which design metadata is defined by key/value pairs describing various attributes of the design and elements are defined in an array of element descriptors. One example of such a design descriptor is as follows:

```
{
  ″design″: {
    ″id″: “abc123″,
    ″creationDate″: ″1-jun-2020″,
    ″dimensions″: {
        ″width″: 1080,
        ″height″: 1080
    },
    ″elements″: [
      {
        ″type″: ″IMAGE″,
        ″top″: 100,
        ″left″: 100,
        ″width″: 500,
        ″height″: 400,
        ″rotation″: 0,
        ″opacity″: 1,
        ″mediaReference″: “Mabc123”
      }
    ],
  }
}
```

In this example, the design metadata defines: a design identifier, a design creation date, and design dimensions (a height and a width). Each design element descriptor includes values defining, for a particular element: the element type, the element position (defined by top and left coordinates/offsets), the element size (defined by width and height), element rotation, element opacity, and an element media reference (e.g. a pointer to/location of the element's media). The mediaReference may, for example, be a reference to a database or other data storage location, a URL, or any other reference that can be resolved to obtain a media item.

Where design elements are defined in an element array, an element's position within the array can be used to define the element's depth on the canvas. I.e. an element defined by the object at array index n is above (and therefore, depending on x/y position and transparency, may occlude or partially occlude) an element defined by the object at array index n−1.

In certain embodiments a design may define a background element. A background element may be defined separately to the elements array or as an element of the element array (e.g. as the first element of the array—array index=0).

In certain embodiments elements may be grouped together. Element groupings may be defined in various ways. In the present embodiments, element groups are defined within group arrays: i.e. an object within the element array defines various attributes of the element group (for example position, size, rotation, opacity, and/or other attributes) as well as the elements that are members of a group (e.g. in a further element array). For an element that is a member of a group, certain attributes (e.g. size, position, rotation, flipped, opacity, etc.) are relative to the group's attributes. For example, if a group position is defined to be 100,200 on the canvas with 50% opacity, and a child element of that group has a position of 10,10 and opacity 100%, the final/observed position of the child element on the canvas will be at position 110,210 with opacity 50%. Continuing with the element array format above, an example of this is as follows:

```
{
  ″design″: {
    ″id″: ″abc123″,
    ...
    ″elements″: [
      { <element A> },
      {
        ″type″: ″GROUP″,
        ″top″: 100,
        ″left″: 100,
        ″width″: 400,
        ″height″: 400,
        ...
        ″children″: [
          {
            ″type″: ″IMAGE″,
            ″top″: 100,
            ″left″: 100,
            ″width″: 200,
            ″height″: 200,
            ″rotation″: 0,
            ″opacity″: 1,
            ″mediaReference″: ″Mabc123″
          },
          {
            ″type″: “VIDEO″,
            ″top″: 200,
            ″left″: 200,
            ″width″: 200,
            ″height″: 200,
            ″rotation″: 0,
            ″opacity″: 1,
            ″mediaReference″: “Vabc123″
          }
        ]
      },
      { <element D> }
    ],
  }
}
```

In this example: the first object of the elements array defines a single element ‘A’ (details/attributes omitted); the second object of the elements array defines a group that includes two elements: an ‘IMAGE’ type element (with media reference “Mabc123”) and a ‘VIDEO’ type element (with media reference “Vabc123”); the third object of the elements array defines a single element {D} (details/attributes omitted).

By way of alternative example, element groups may be defined by a group identifier (e.g. an element metadata item that identifies a particular group a given element is a member of).

In order to display a given design, the device independent format of the design is processed by a computer processing system to render the design on a display. Similarly, the device independent format of a design can be processed to export the design in other formats for sharing and/or publishing (e.g. JPEG, GIF, MPEG4, PDF, or any other desired output format).

It will be appreciated that the specific design and element descriptor formats provided above are by way of example only. Alternatives are possible, and may well define additional/alternative design and/or element attributes to those discussed above.

As noted, a design can be generated from a design template.

A design template is a pre-prepared design that is intended to be adapted by a user into a final design. A template may, for example, define a canvas size as well as one or more design elements.

In use, a design template can be edited by a user, for example by adding new design elements, removing design elements defined by the template, replacing placeholder elements with user-selected media items, and/or editing design elements that are defined by the template and/or have been added by the user.

Design templates can also be stored in a format such as the design descriptor format described above.

In certain embodiments, design templates (and/or pre-rendered template bundles generated based thereon) can be associated with one or more template styles (and/or other groupings). A design template/template bundle may be associated with a particular style (or other group) in various ways. For example, a list (or other data structure) may maintained associating template/template bundle identifiers with style (or other group) identifiers. Such a list may be stored by design creation application 112 and/or server application 104. Alternatively (or in addition), descriptors for design templates/template bundles may include a metadata item that defines a ‘style’ (and/or other group) attribute. As discussed below, the style/group association(s) may be used to display design templates together and/or help a user browse and/or search for templates. A design template may be associated with one or more groups, pre-defined or otherwise. By way of example, groups such as ‘black and white’, ‘polaroid’, ‘paper’, ‘scribbles’, ‘minimalist’, and/or any other appropriate group(s) may be defined.

The present disclosure describes, inter alia, processing performed to take an existing (complete) design template and generate a pre-rendered template bundle that corresponds to that complete design template. The pre-rendered template bundle can then be used in a content-driven design creation process.

FIG. 1 depicts a networked environment 100 which includes a server system 102 and a user system 110 that are interconnected via a communications network 120 (e.g. the Internet).

Server system 102 includes a front-end server application 104. The server application 104 is executed by a computer processing system to configure the server system 102 to provide server-side functionality to one or more corresponding client applications (e.g., client 112 running on user system 110).

The server-side functionality provided by server application 104 will depend on the purpose of the server. For example, server application 104 may be a server side application for a client-server design creation platform and provide operations such as user account management, login, and design specific functions—for example creating, saving, publishing, and sharing designs. Alternatively, server application 104 may be content server and provide operations to receive and respond to requests for content (e.g. media items).

To provide the server-side functionality, the server application 104 comprises one or more application programs, libraries, APIs or other software elements. For example, where the design creation application 112 is a web browser, the server application 104 will be a web server such as Apache, 6S, nginx, GWS, or an alternative web server. Where the design creation application 112 is a specific application, the server application 104 will be an application server configured specifically to interact with that design creation application 112. Server system 102 may be provided with both a web server and application server.

Server system 102 also includes a data store 106. Data store 106 may be used to store various data, including for example user account data, templates, user created designs, and/or other data.

In order to provide server side functionality to clients, server system 102 will typically include additional functional components to those illustrated and described. As one example, server system 102 will typically include one or more firewalls (and/or other network security components) and load balancers (for managing access to the server application 104).

The server application 104 (and functions performed thereby) may be implemented by hardware, software (data and computer readable instructions which are stored in memory and executed by one or more computer processing systems), and/or a combination of hardware and software.

The precise hardware architecture of server system 102 will vary depending on implementation, however may well include multiple computer processing systems (e.g. server computers) which communicate with one another either directly or via one or more networks, e.g. one or more LANS, WANs, or other networks (with a secure logical overlay, such as a VPN, if required).

User system 110 hosts a design creation application 112. Via the design creation application 112 a user can perform various operations such as creating, editing, saving, retrieving/accessing, publishing, and sharing designs. In certain implementations, client application 112, when executed by the user system 110, configures the user system 110 to provide client-side functionality for/interact with the server application 104 of the server system 102 to perform design-related operations. In alternative implementations, design creation application 112 is a stand-alone application and does not need to interact with server system 102.

Where design creation application 112 interacts with server application 104 it may be a web browser application (such as Chrome, Safari, Internet Explorer, Opera, or an alternative web browser application) which accesses the server application 104 via an appropriate uniform resource locator (URL) and communicates with server application 104 via general world-wide-web protocols (e.g. http, https, ftp). Alternatively, the design creation application 112 may be a native application programmed to communicate with server application 104 (if and when required) using defined application programming interface (API) calls.

In the present example, design creation application 112 includes a pre-rendered template bundle generation module 114 and a content-driven design generation module 116. As discussed below, the pre-rendered template bundle generation module 114 is involved in generating pre-rendered template bundles and the content driven design generation module 116 is involved in generating designs based on pre-rendered template bundles.

In the present example, the pre-rendered template bundle generation module 114 and content driven design creation module 116 are described as modules of the design creation application 112—for example add-ons, plug-ins, or other software components that integrate with and expand the functionality of the design creation application 112. The functionality provided by one or both of these modules could, however, be performed by separate/stand-alone applications. As a further alternative, the functionality provided by one or both of these modules could be native functionality of the design creation application 112.

User system 110 also includes a local data store 118. Local data store 118 is computer readable storage that is locally accessible to the user system 110. Local data store 118 may be used to store, for example, design creation application data (such as designs that have been created by the user, design templates, and/or other data), user media items (for example photos/images and videos taken by the user with the user system 110 and/or downloaded to the user system 110 from another system), application preferences (e.g. default media locations, preferred publication endpoints, publication endpoint access credentials), and/or other data.

User system 110 may be any computer processing system which is configured (or configurable) by hardware and/or software to perform the functions described herein. By way of example, user system 110 may be a desktop computer, a laptop computer, a netbook computer, a tablet computing device, a mobile/smart phone device, a personal digital assistant, or an alternative computer processing system.

Although not illustrated in FIG. 1, user system 110 will typically have additional applications installed thereon, for example at least an operating system application.

The architecture described above and illustrated in FIG. 1 is provided by way of example only, and variations are possible.

For example, while the pre-rendered template bundle generation module 114 and content driven design generation module 116 have been described and illustrated as being part of/installed at the user system 110, either or both of these modules (or applications performing the functionality described be either/both of the modules) could be installed on server system 102 (e.g. as part of server application 104 or an alternative application running on server system 102). In this case functionality of the modules may be accessed/invoked from the application 112 over network 120.

As a further example, the functionality provided by either or both of the pre-rendered template bundle generation module 114 and content driven design generation module 116 could be provided as an entirely separate service—e.g. running on a separate server system to server system 102 and communicating with design creation application 112 (and/or server system 102) as required to perform the functionality described herein.

Still further, many of the functions described herein could be performed by a stand-alone computing device (e.g. the ‘user system’ 102 described below) configured to operate by an appropriate software application (e.g. design creation application 112) without need to interact with a remote system (such as server such as 102).

The functions described herein are implemented using one or more computer processing systems.

For example, in networked environment 100 described above, user system 110 is a computer processing system (for example a personal computer, tablet/phone device, or other computer processing system). Similarly, the various functional components of server system 102 are implemented using one or more computer processing systems (e.g. server computers or other computer processing systems).

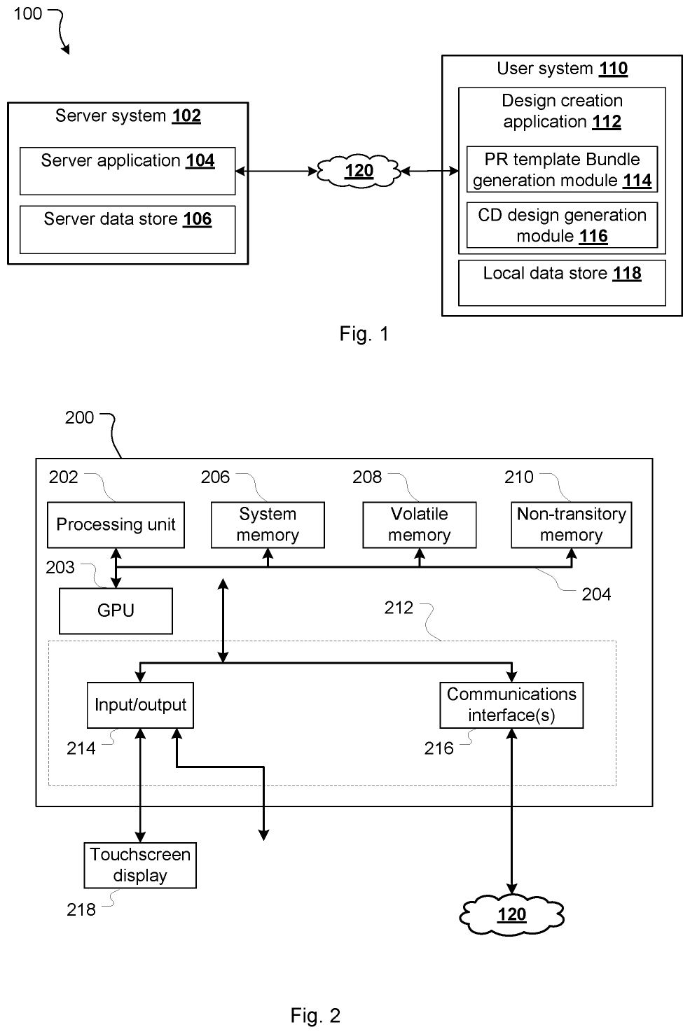

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one computer processing unit 202 (e.g. a central processing unit or other computer processing unit). In some instances, computer processing system 200 may additionally include one or more additional processing units (e.g. one or more graphics processing units 203 and/or other processing units). In some instances, where a computer processing system 200 is described as performing an operation or function all processing required to perform that operation or function will be performed by processing unit 202 (alone or in conjunction with any additional processing units, such a graphics processing unit 203). In other instances, processing required to perform that operation or function may also be performed by remote processing devices accessible to and useable by (either in a shared or dedicated manner) system 200.

Through a communications bus 204 the general processing unit 202 (and, where present, graphics processing unit 203) is in data communication with a one or more machine readable storage (memory) devices which store instructions and/or data for controlling operation of the processing system 200. In this example system 200 includes a system memory 206 (e.g. a BIOS), volatile memory 208 (e.g. random access memory such as one or more DRAM modules), and non-transitory (or non-volatile) memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, connection between the device and system 200 may be via wired or wireless hardware and communication protocols, and may be a direct or an indirect (e.g. networked) connection.

Wired connection with other devices/networks may be by any appropriate standard or proprietary hardware and connectivity protocols. For example, system 200 may be configured for wired connection with other devices/communications networks by one or more of: USB; eSATA; Thunderbolt; Ethernet; HDMI; DisplayPort. Other wired connections are possible.

Wireless connection with other devices/networks may similarly be by any appropriate standard or proprietary hardware and communications protocols. For example, system 200 may be configured for wireless connection with other devices/communications networks using one or more of: infrared; BlueTooth; WiFi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

System 200 includes one or more input/output interfaces 214 for connecting to/communicating with input and/or output devices. Generally speaking, and depending on the particular system in question, devices to which system 200 connects—whether by wired or wireless means—include one or more input devices to allow data to be input into/received by system 200 for processing by the processing unit 202, and one or more output device to allow data to be output by system 200. Example devices are described below, however it will be appreciated that not all computer processing systems will include all mentioned devices, and that additional and alternative devices to those mentioned may well be used.

For example, system 200 may include or connect to one or more input devices by which information/data is input into (received by) system 200. Such input devices may include keyboards, mice, trackpads, microphones, accelerometers, proximity sensors, GPS devices, camera/image capture devices and the like. System 200 may also include or connect to one or more output devices controlled by system 200 to output information. Such output devices may include devices such as LCD displays, LED displays, QLED displays, plasma displays, touch screen displays, speakers, vibration modules, LEDs/other lights, and such like. System 200 may also include or connect to devices which may act as both input and output devices, for example memory devices (hard drives, solid state drives, disk drives, compact flash cards, SD cards and the like) which system 200 can read data from and/or write data to, and touch screen displays which can both display (output) data and receive touch signals (input).

System 200 also includes one or more communications interfaces 216 for communication with a network, such as network 180 of environment 100 (and/or a local network within the server system 102 or OS 120). Via the communications interface(s) 216 system 200 can communicate data to and receive data from networked devices, which may themselves be other computer processing systems.

System 200 may be any suitable computer processing system, for example, a server computer system, a desktop computer, a laptop computer, a netbook computer, a tablet computing device, a mobile/smart phone, a personal digital assistant, or an alternative computer processing system.

System 200 stores or has access to computer applications (also referred to as software or programs)—i.e. computer readable instructions and data which, when executed by the processing unit 202, configure system 200 to receive, process, and output data. Instructions and data can be stored on non-transitory machine readable medium accessible to system 200. For example, instructions and data may be stored on non-transitory memory 210. Instructions and data may be transmitted to/received by system 200 via a data signal in a transmission channel enabled (for example) by a wired or wireless network connection over a communications interface such as 216.

Applications accessible to system 200 will typically include an operating system application such as Microsoft Windows, Apple macOS, Apple iOS, Android, Unix, or Linux.

System 200 also stores or has access to applications which, when executed by the processing unit 202, configure system 200 to perform various computer-implemented processing operations described herein. For example, and referring to the networked environment of FIG. 1 above: user system 110 includes a design creation application 112 (which, in the present example, includes a pre-rendered template bundle generation module 114 and a content driven design generation module 116) which configures the user system 110 to perform the operations described herein.

In some cases, part or all of a given computer-implemented method will be performed by system 200 itself, while in other cases processing may be performed by other devices in data communication with system 200.

In certain embodiments, user device 110 is a portable computer processing system such as a smart phone, tablet, or laptop computer. In these embodiments, the portable computer processing system may have (amongst other input/output devices) a touchscreen display 218 for both display and input. In other embodiments, user device 110 may have other input/output devices, such as a keyboard, mouse, and display (touchscreen or otherwise).

The present disclosure refers to complete templates and pre-rendered template bundles. For ease of reference, ‘pre-rendered template bundles’ will also be referred to as simply ‘template bundles’.

The distinction between a complete template and a template bundle (i.e. a pre-rendered template bundle) will become apparent from the following description which describes how a complete template is processed to generate a corresponding template bundle, and how a template bundle is processed to generate a design in a content driven design creation process.

Generally speaking, however, a complete template is a ‘normal’ version of a design template. A complete template is defined by a design descriptor (e.g. as outlined above) which may define any type of element (e.g. raster and/or vector elements). In a complete template, actual element media for any given element may be located at any available location (e.g. at server data store 106 of server system 102, an alternative remote system accessible over a network via a URL or the like, a local data store). A complete template is used where a user wishes to avail themselves of typical editing controls provided by a design creation application.

A template bundle includes a template bundle descriptor and template bundle media items. To generate template bundle media items, element media items from the corresponding complete template are (if required) retrieved and converted to raster elements. Furthermore, in certain embodiments multiple complete template element media items may be converted into a single template bundle media item. Each template bundle media item becomes an element within the template bundle descriptor, which is generated to appropriately define those media items within the pre-rendered template (e.g. their positions, sizes etc.). This allows the template bundle to be processed more efficiently than its corresponding complete template in order to generate and render a design based thereon. Where a pre-rendered template is used, however, fewer editing options are available: specifically, a user is limited to replacing placeholder elements defined by the pre-rendered template with selected media items.

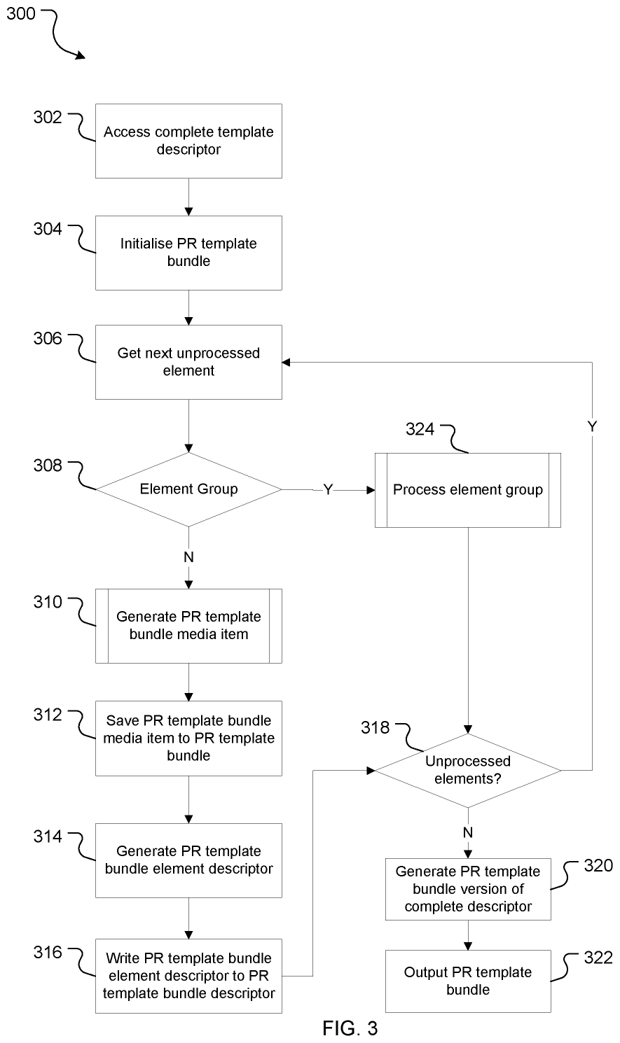

Turning to FIG. 3, a process 300 for generating a template bundle based on a corresponding complete template will be described.

In the present example, the process 300 is described as being performed by the template bundle generation module 114 (referred to module 114 in this section for brevity). Process 300 could, however, be performed by an alternative module or application, running on user system 110 or a separate system. For example, process 300 could be performed by server application 104 (or an alternative application) running on server system 104, or by an application running on an alternative system.

Process 300 may be triggered in various ways. For example, process 300 may be performed in response to receiving a user input (via user system 110) selecting a particular complete template and requesting creation of a corresponding template bundle. Alternatively, process 300 may be automatically performed any time a new complete template is created and saved by a user.

At 302, module 114 accesses a complete template descriptor. The complete template descriptor may be accessed from a locally accessible data store of the user system 110 (e.g. data store 118) or a remote data store (e.g. server data store 106, accessed via server application 104, or a data store maintained by and accessible from an alternative remote system).

At 304, module 114 initialises a template bundle.

Initialising a template bundle includes initialising template bundle descriptor. This involves creating a new template bundle descriptor, generating new metadata for the descriptor, and copying (or adapting) relevant metadata from the complete template descriptor into it. Relevant metadata copied to (or adapted for) the template bundle descriptor may include, for example, metadata such as an animation type.

At 306, module 114 retrieves the next unprocessed element descriptor from the complete template descriptor. In the present example, element descriptors from the complete template descriptor are processed in order, for example, by iterating over an elements array as described above from the first array item to the last array item.

In embodiments where the design descriptor format defines a design background separately to design elements (e.g. not in an elements array per above), the design background may be processed in a similar (or the same) way as a design element.

In the present example, at 308 module 114 determines if the current element descriptor defines an element that is a member of an element group. If not, processing proceeds to 310. If the element is a member of a group, processing proceeds to 324, which is described below with reference to FIG. 5, before continuing to 318.

In the present example, and referring to the example design descriptor above, an element group is identified by a sub-array within the elements array. In alternative embodiments, an element group may be identified by reference to a group identifier or other element metadata item.

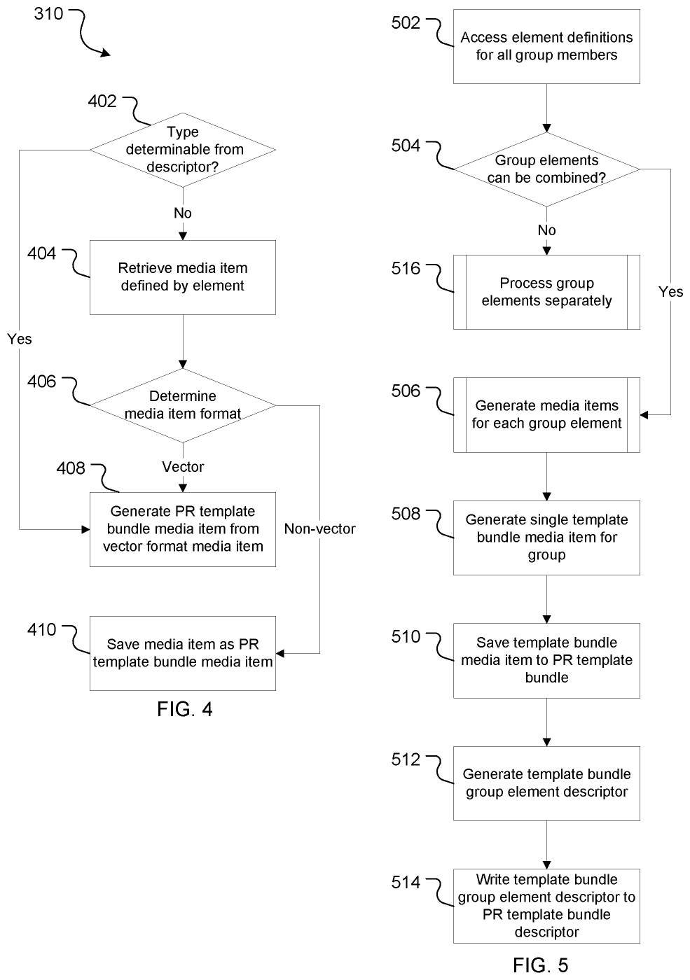

At 310, module 114 generates a template bundle media item corresponding to the current element being processed. This process is described below with reference to FIG. 4.

At 312, module 114 saves the template bundle media item generated at 310 to the template bundle initialised at 304.

At 314, module 114 generates a template bundle element descriptor for the template bundle media item generated at 310. Metadata for the template bundle element descriptor metadata is generated based on the metadata of the original element descriptor (i.e. the element's descriptor in the complete template). For example, metadata describing the element's: position (e.g. x/y coordinates); size; opacity; rotation; flip orientations; whether the element is a placeholder element; and/or other relevant attributes of the element can be read from the original element descriptor and included (or adapted for inclusion) in the template bundle descriptor. For its media item, the template bundle element descriptor stores a reference the template bundle media item generated at 310 and saved to the template bundle at 312. Any appropriate mechanism for referencing a template bundle media item can be used. For example, a reference may be a unique string value generated for the media item—e.g. “58D941013FDA5BB2C1B0853641C23C78”. The unique string could be generated in any appropriate way, for example a hash/binary value encoded in hexadecimal (such as a MD5 hash). The reference/identifier is then matched to the template bundle media item—e.g. by the template bundle media item being named using that unique value (e.g. 58D941013FDA5BB201B0853641023078.png).

At 316, module 114 writes the template bundle element descriptor generated at 314 to the template bundle descriptor. In the present example, this is performed by appending the template bundle element descriptor to the end of existing template bundle descriptor's elements array. In the present embodiment, where depth is determined by array position, this preserves the element's depth in the template bundle.

At 318, module 114 determines if there are any unprocessed elements in the complete template descriptor. If so processing returns to 306 to select the next unprocessed element descriptor. If not, processing proceeds to 320.

At 320, all elements defined by the complete template have been processed. In the present embodiment, module 114 generates a template bundle version of the complete template descriptor and writes this to the template bundle descriptor.

By way of example, module 114 may generate an encoded version of the complete design descriptor and store this as a single value in the pre-rendered design template descriptor—e.g. in a key/value pair such as:

“completeTemplateDescriptor”: “eyJ . . . fX0=”

The encoded version of the complete design descriptor may be generated by a base64 encoding algorithm, or any other appropriate encoding algorithm.

As described below, the version of the complete template descriptor generated at 320 is not used to generate a design as part of a content driven design creation process. Rather, it retrieved and used in the event that a user decides they wish to edit a design that has been generated based on a template bundle.

At 322, module 114 finalises and outputs the template bundle. The template bundle includes the template bundle descriptor (as initialised at 304 and updated throughout process 300) and template bundle media items (as generated and saved to the template bundle throughout process 300).

Module 114 may be configured to output the pre rendered template bundle to any appropriate location or endpoint. For example, in certain embodiments pre rendered template bundles are included in (or provided as automatic updates to) design creation application 112—i.e. so that they are automatically available to users who install/update design creation application 112 on their user system 110. In this case, module 114 may output a template bundle by sending it to a server application such as 104, which receives the template bundle and performs operations to have it included in a design creation application install and/or update package. Template bundles may also, or alternatively, be made available for users of design creation application 112 to search and download. In this case, a template bundle may once again be output by sending to a server application such as 104 which performs operations to make the bundle available for searching and download. As a further example, template bundle may be output be being saved to locally accessible memory, such as local data store 118.

The operations described in process 300 can be performed (or adapted to be performed) in various ways to generate a template bundle. For example, in the embodiment described above module 114 processes each element defined by a complete template in turn to generate a corresponding template bundle media item element descriptor. In alternative embodiments, module 114 may process the complete template in a first pass to gather all media items for all elements (either by retrieving media items from referenced locations or extracting in-line media item descriptors from element descriptors themselves). If any media items cannot be accessed (e.g. due to a broken reference all the like), module 114 may generate an error (e.g. ‘media item(s) [a, b, c, . . . ] cannot be retrieved) and end the template bundle generation process. If all media items are accessible, module 114 can then save/convert each media item as required, either sequentially or in parallel (e.g. per operations 406, 408, and 410), and generate save corresponding template bundle element descriptors (again sequentially or in parallel).

At 310 of process 300 module 114 generates a template bundle media item for the current element being processed. This process is described with reference to FIG. 4.

In the present example, the type of an element's media item may be able to be determined from the element descriptor alone (e.g. the value stored against the element's “type” key) without having to retrieve the element's media item. For example, and as described above, certain elements may define in-line media items (e.g. an element's descriptor includes a vector graphic description rather than a reference to an external file that includes a vector graphic description). In this case, at 402 module 114 determines if the element descriptor for the element being processed defines an in-line media item. If so, the media item can be processed without having to retrieve it from an external source.

Module 114 may be configured to determine if a media element type can be determined from the descriptor in various ways. For example, module 114 may be configured to make this determination based on an element type attribute (with certain element types reserved for/known to define in-line media items—e.g. a SHAPE type, a TEXT type, and/or any other type defining an in-line media item). Alternatively, module 114 may determine this from the descriptor itself—i.e. by accessing the descriptor to see whether it is a reference to a media item or actually defines the media item.

In the present example, only vector format media items are defined as in-line media items. Accordingly, if module 114 determines that the media item type can be determined from the element descriptor processing proceeds to 408. In alternative embodiments, if in-line media items can be of different types processing can proceed to the operation for processing the relevant media type determined at 402.

If the type of an element's media item cannot be identified from the element's metadata, module 114 may then retrieve the media item.

In implementations that do not permit element descriptors to define in-line media items operation 402 is skipped.

At 404, module 114 retrieves the media item of the element being processed. As described above, in some cases the element descriptor may itself include the media item (i.e. an in-line media item), in which case retrieving the media item involves module 114 extracting the media item from the element descriptor (e.g. extracting text describing a vector graphic). In other cases, the element descriptor may define a reference to the media item. For example, the reference may be a unique identifier that can be used to retrieve the media item, typically from a remote system (e.g. server system 102, via a server application such as 104).

At 406, module 114 determines a format of the media item retrieved at 404. In the present example, module 114 determines if the media item is a vector format media item (in which case processing proceeds to 408) or a non-vector format media item (in which case processing proceeds to 410). Non-vector format media items may, for example, be raster format items, video items, audio items, or other format media items.

At 408, module 114 processes the vector format media item to generate a corresponding raster-format template bundle media item. Generation of the media bundle template item is then complete.

In the present embodiment, all graphic template bundle media items are raster format media items. Any appropriate raster format may be used, for example .jpg, .png, or an alternative raster format.

At 410, module 114 saves a copy of the non-vector format media item as the template bundle media item. Generation of the media bundle template item is then complete.

At 408 and 410, and as described above, in the present embodiment a given template bundle media item is saved with a file name that is used to reference the media item in the corresponding template bundle element descriptor.

In alternative implementations, the determination performed at 406 may distinguish between additional media item formats, and allow media items of those different formats to be processed in different ways. E.g. the determination (and subsequent processing) may be based on a more specific format type of the media item in question. For example, rather than determining if the media item is a non-vector format media item, module 114 may determine if the media item is a .jpg, a .gif, a .png, a .wav, a .mov, or an alternative format item and perform specific processing (e.g. format conversion, down-sizing, or other processing) based thereon. Similarly, rather than determining if the media item is a vector format media item module 114 may determine if the media item is a .svg, a .dxf, or an alternative vector format media item.

In the present example, module 114 determines if the currently selected element is a member of a group and, if so, proceeds to 324. The processing of groups in this example is described with reference to FIG. 5. Generally speaking, this involves determining if the elements of a group can be combined into a single template bundle element and, if so, generating such an element.

At 502, module 114 accesses (from the compete template) element definitions of all elements that are members of the element group currently being processed (i.e. the element group that current element is a member of).

At 504, module 114 determines if the elements in the group can be combined.

Module 114 may determine if the elements of a group can be combined based on one or more combining conditions. By way of example, a combining condition may based on whether any of the group elements is a placeholder elements: i.e. if any element of the group is a placeholder element module 114 determines that the group elements cannot be combined.

As another example, a combining condition may be based on an element group's animation type (e.g. an animation defining how an element group appears, disappears, or moves while displayed). Some animation types may require an elements of a group to be treated as individual elements, in which case a group's elements cannot be combined. As one example of this, an animation may involve a wobble or the like where elements wobble in place, and in this case applying the animation to elements within a group independently may be appropriate. Other animation types, however, may operate on a group of elements as a whole. For example, a fade type animation may be appropriately applied to a group of elements as whole. In this case, combining the elements in the group may be possible (depending on the evaluation of any other non-combining conditions).

Additional and/or alternative combining conditions (based on other attributes of a group or a group's elements) may be defined.

In this example, if any combining condition is met (e.g. the element group includes a placeholder element or the element group is associated with an animation type that precludes combining) module 114 determines that the group elements cannot be combined and processing proceeds to 516. If neither combining condition is met, module 114 determines that the group elements can be combined and processing proceeds to 506.

At 506, module 114 generates media items for each element of the element group. For each element of the element group generation of a media item may be performed in a process that is similar to (or the same as) 310 described above.

At 508, module 114 processes the media items generated at 506 to generate a single template bundle media item for the group.

In order to generate the single template bundle media item for the group, the media items generated at 506 can be combined in various ways. In the present example, module 114 sorts the media items generated at 506 in depth order (if they are not already in this order), renders the media items (taking into account their positions, rotations, opacities, and any other relevant attributes), then saves a single, flattened media item.

At 510, module 114 saves the single template bundle media item generated at 506 to the template bundle initialised at 304.

At 512, module 114 generates a single template bundle group element descriptor for the media item generated at 508.

Metadata for the template bundle group element descriptor is generated based on the metadata of the individual element descriptors of the group's elements (as defined in the complete template). These are used, for example, to determine the overall position (e.g. x/y coordinates) of the single group element, the size of the group element, a scale of the group element; an anchor point of the group element (used to determine an origin for rotation).

For its media item, the template bundle group element descriptor references the single template bundle media item generated at 508 and saved to the template bundle at 510.

At 514, module 114 writes the template bundle group element descriptor generated at 512 to the template bundle descriptor. In the present example, this is performed by appending the template bundle group element descriptor to the end of existing template bundle descriptor's element array.

At 516, module 114 has determined that the group elements cannot be combined. In this case, module 114 processes each element of the group separately (i.e. without combining the group elements' media items). Processing group element's may be performed in a similar fashion as described in process 300, for example by: selecting the first element of the group (e.g. per 306), generating and saving a template bundle media item for that element (e.g. per 310 and 312), generating and writing a template bundle element descriptor for the element (e.g. per 314 and 316), then determining if further element sin the group need to be processed (e.g. per 318).

In alternative embodiments, operations 308 and 324 are omitted and each element is kept separate/processed the same way regardless of whether it is a member of a group or not.

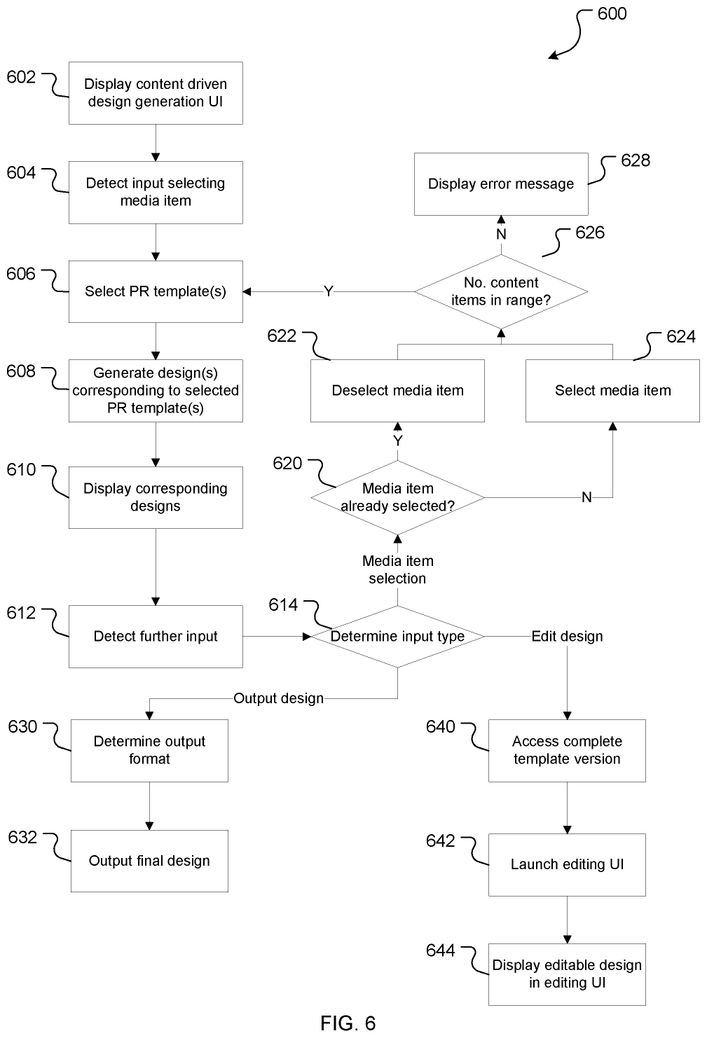

Turning to FIG. 6, a process 600 for generating a design using a template bundle (e.g. a template bundle generated as per process 300) and user media items will be described.

In the present example, process 600 is described as being performed by the content driven design generation module 116 (referred to module 116 in this section for brevity). Process 600 could, however, be performed by an alternative module or application running on user system 110.

In other implementations, certain operations of process 600 could be performed by a separate system—e.g. server application 104 (or an alternative application) running on server system 104, or by an application running on an alternative system. In this case, however, user inputs are still received at user system 110 (and, as necessary, communicated to the remote system) and display is by user system 110 (based on locally generated data and/or data received from the remote system).

Process 600 assumes that one or more template bundles are available to module 116. In the present embodiment, template bundles are included in an installation and/or update package to the design creation application 112. When the design creation application 112 is installed or updated, template bundles are saved to local memory, for example to local data store 118. Installation and/or update packages may be provided to user system 110 in any appropriate way, for example by downloading from a remote server (such as server system 102, an application store, or an alternative server) via network 120 or via physical media (e.g. a disk or the like).

In other embodiments, a user may also or alternatively search for and access template bundles from a remote location, such as server system 102.

At 602, module 116 causes an initial content driven design generation user interface to be displayed on a display of user device 110. This may, for example, be in response to detecting a user input to commence creation of a design via the content driven design generation process, or it may be a default user interface displayed on application launch.

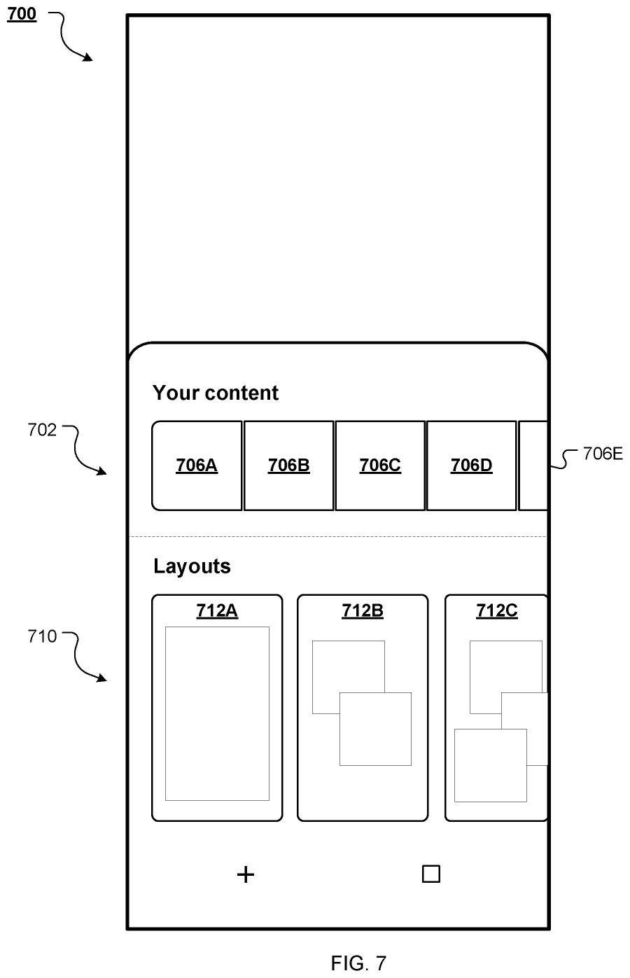

One example of an initial content driven design generation user interface is described below with reference to FIG. 7. The user interface includes a media item selection region (such as region 702) displaying media items that can be selected by a user (e.g. media item thumbnails 706).

In the present example, the media items displayed in the media items selection region are retrieved by module 116 from local data store 118. Module 116 may be configured to retrieve media items from a default location, for example a ‘recent photos’ folder (i.e. a folder of recent photos that have been taken using a camera of user system 110 or saved at user system 110), a ‘favourite photos’ folder, or an alternative location.

At 604, module 116 detects user input selecting a media item in the media item selection region. This may be referred to as a first item selection user input. The user input detected may, for example, be a tap gesture or the like at a location of the user system display corresponding to the media item. In response to detecting user input selecting the media item at 604, module 116 adds the selected media item (or a reference thereto) to a list of selected media items.

At 606, module 116 selects at least one (typically multiple) template bundles.

Module 116 is configured to select template bundles based on the number of media items that have been selected (e.g. the number of media items in the list of selected media items). For example, if one media item has been selected (which will be the case where 606 follows 604), module 116 selects template bundles with descriptors that define a single placeholder element. More generally, if n media items have been selected module 116 selects template bundles with descriptors that define n placeholder elements.

In addition to selecting template bundles based on the number of media items that have been selected, module 16 may apply other selection criteria. For example, module 116 may be configured to select (from the subset of template bundles with the requisite number of placeholder elements): all such bundles; a set number n of template bundles (e.g. n=5 or any other number); a set of most commonly used template bundles; a set of template bundles flagged as being a particular template bundle style; a random selection of template bundles; or any other set of template bundles.

At 608, module 116 processes the template bundle(s) selected at 606 (or a subset thereof) to generate corresponding designs.

Processing a given template bundle to generate a corresponding design involves rendering any non-placeholder elements defined by the template bundle descriptor, in addition to rendering the user selected media items in place of the placeholder element(s) defined in the template bundle descriptor. Non-placeholder elements are rendered into a destination texture/image with the source being the pre-rendered template bundle media item. This avoids having to retrieve the original media items which is relatively slow.

In the present embodiment, where multiple placeholder elements are present, user selected media items are associated with placeholder elements based on the order the media items are selected and the order of the place holder elements in the template bundle descriptor. For example, the first media item selected by a user (which will be the first item in the list of selected media items) replaces the first placeholder element in the template bundle descriptor, the second media item selected by the user replaces the second placeholder element and so forth.

Rendering a user selected media item in place of a placeholder element can be performed in various ways. In certain embodiments, module 116 determines a region defined by the placeholder element (e.g. a position, width, and height). Module 116 then centres and aspect fills the user selected media item in the region defined by the placeholder element (i.e. uniformly scaling the user selected media item to fill the region, clipping/trimming any portions of the user selected media item that fall outside the region).

At 610, module 116 causes one or more of the corresponding designs generated at 608 to be displayed on the display of the user system 110.

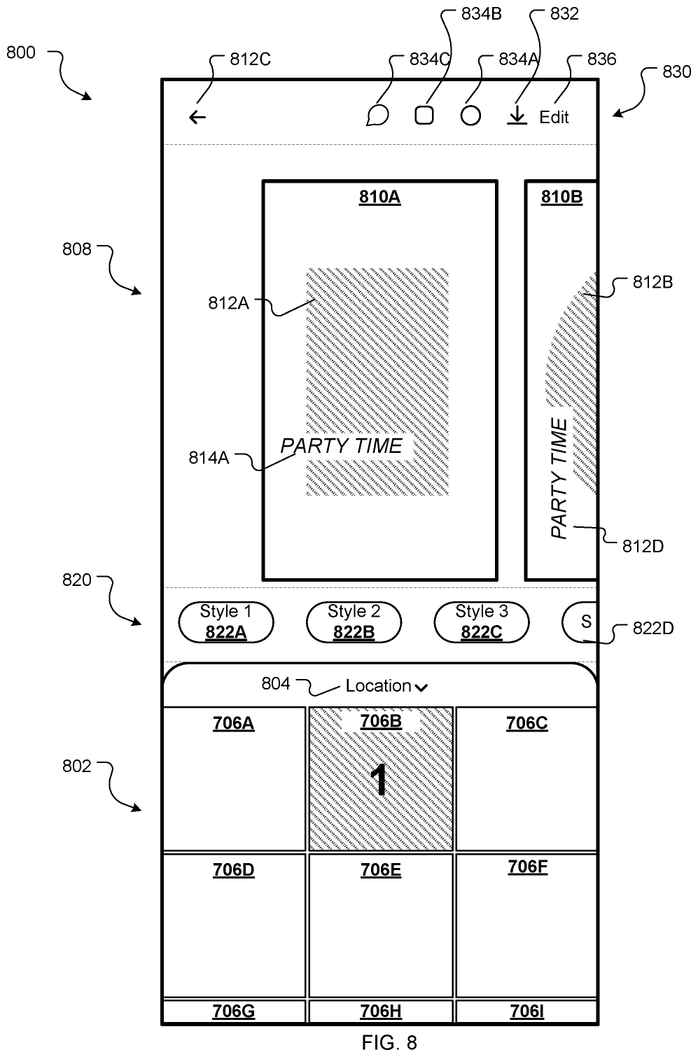

In the example user interfaces described below, module 116 displays the corresponding designs in a further user interface 800 (FIG. 8, with corresponding designs 810). In this example module 116 displays a sequence of corresponding designs 810 which a user can scroll/swipe through.

At 612, module 116 detects further user input.

At 614, module 116 determines the type of the further user input. In this particular example, the user input may be: a further item selection input to select a further media item (in which case processing proceeds to 620); an item deselection input to deselect a currently selected media item (in which case processing also proceeds to 620); a generate output input to output a design (in which case processing proceeds to 630); or an edit design input to edit a design (in which case processing proceeds to 640). Other user inputs are possible. For example a user may navigate through designs (e.g. by swiping/scrolling or otherwise interacting with device 110), activate a discard design control (in which case processing may return to 602), activate a close application control, and/or perform other operations.

At 620, module 116 has determined the further user input to be input selecting a media item. User input to select a media item may, for example, be a tap gesture on a media item thumbnail such as 706 of FIG. 8 described below.

At 620, module 116 determines if the media item selected has already been selected. Module 116 may make this determination by checking to see if the media item (or a reference thereto) is in the list of selected media items.

If, at 620, the media item has already been selected, processing continues to 622 where module 116 deselects the media item, e.g. by removing it (or the reference thereto) from the list of selected media items. Processing then continues to 626.

If, at 620, the media item has not already been selected, processing continues to 624 where module 116 selects the media item, e.g. by adding it (or a reference thereto) to the list of selected media items. Processing then continues to 626.

At 626, module 116 determines if the number of currently selected media items (e.g. the number of items in the list of selected media items) is in a permissible range. The permissible range may define a minimum number of user selected media items (e.g. 1)<=number of selected media items<=a maximum number of user selected media items. In this case the permissible range requires there to be at least one selected media item and no more than max selected media items, the value of max aligning with the greatest number of placeholder elements defined by one or more of the template bundles.

If the number of currently selected media items is in the permissible range, processing returns to 606 (described above).

If the number of currently selected media items is not in the permissible range, processing proceeds to 628. At 628 module 116 may cause an error message to be displayed, for example indicating that no media items have been selected or that too many media items have been selected. In addition to, or instead of, displaying an error message, if no media items are selected module 116 may return to 602 (and the initial user interface), and if too many media items are selected module 116 may ignore the last selected media item and await further input at 612.

At 630, module 116 has determined the further user input to be user input selecting to output a design. User input to a output a design may, for example, be a activation of a save control (such as control 832 of interface 800 below), activation of a publish control (such as control 834 of interface 800 below), activation of a share control, or activation of any other control indicating the design is to be finalised and output.

In example interface 800 described below, the design selected for finalisation is the design that is entirely displayed on the display (e.g. design 810A). In other implementations, a user may actively select a particular design for finalisation, for example by tapping (or otherwise selecting) a particular design.

At 630, module 116 determines the output format required for the particular finalisation option selected by the user. For example, if the user selects to save the design, the output format may be a raster format such as JPEG, PNG, MP4. In some implementations, module 116 may provide an output format selection interface allowing a user to select a particular output format.

At 632, module 116 outputs the final design.

For example, if the design is to be saved, module 116 outputs the design by saving it to a specified save location. This may be a default save location or a user-specified save location. The save location may be a local save location (e.g. local data store 118 of user system 110) or a remote save location (e.g. a server data store such as 106 accessed via a server application such as 104).

As another example, if the design is to be output to a publishing location (e.g. by being posted on a social media site, a blogging site, an image sharing site, or an alternative publication endpoint), module 116 outputs the design by sending it to the relevant publication endpoint. In this case module 116 may also access any publication endpoint credentials required by the publication endpoint to permit publication of the design thereon. Such credentials may be input by a user at the time of outputting the design or may have been previously entered for such a purpose and retrieved by module 116 from memory (e.g. local data store 118).

As a further example, if the design is to be output by sharing in an electronic communication (e.g. an email, SMS, instant message application message, or other communication), module 116 may launch an appropriate application for such a communication (e.g. an email application, an SMS application, an instant message application), create the communication (e.g. an email, an SMS, an instant message) and attach the design thereto, ready for a user to add any other required information (e.g. addressee information) and send.

Once module 116 has output the final design the process may return to 602 to allow the user to generate a further design.

At 640, module 116 has determined the further user input to be user input selecting to edit a design. User input to edit a design may, for example, be activation of an edit control (such as control 836 of interface 800 below).

In example interface 800 described below, the design selected for editing is the design that is entirely displayed on the display (e.g. design 810A). In other implementations, a user may actively select a particular design for editing, for example by tapping (or otherwise selecting) a particular design.

At 640, module 116 retrieves the version of the complete template descriptor that is included in the template bundle descriptor of the pre rendered template bundle on which the selected design was based. If encoded, the complete template descriptor is decoded.

At 642, module 116 displays a design editing interface on a display of user system 110. The design editing interface may be any editing interface (e.g. a ‘normal’ editing interface provided by design creation application 112).

At 644, module 116 processes the version of the complete template descriptor to generate/display an editable design in the editing user interface. In doing so, module 116 includes user selected media items in place of placeholder elements.

It should be noted that while the initial appearance of the editable design displayed at 644 (in the editing user interface) may be identical to the appearance of that design as displayed at 610, they are based on two different design descriptors. The design displayed at 610 is based on a template bundle descriptor. As such, all vector elements from the original complete design have been converted to raster elements (and in some cases multiple elements have been converted to a single raster element). In contrast, the design displayed at 644 is based on a complete template. As such any vector elements are rendered as vector elements (and have associated editability), and no collapsing of multiple elements to a single element has occurred (thus retaining the ability to handle those multiple elements independently).

Following 644 a user can edit the design displayed at 644 as desired (and output/save/publish the design via any controls made available through the editing user interface).

While operations 642 and 644 are described as being performed by module 116, these operations could be performed by an alternative module (or an alternative application). For example, on receiving user input to edit a selected design, module 116 may retrieve the version of the complete template descriptor, decode this (if required), and pass it to an editing module/application together with the user selected media item(s) (or reference(s) thereto).

Example user interfaces will be described with reference to FIGS. 7, 8, 9 and 10.

FIG. 7 displays a content driven design generation user interface 700. Interface 700 may, for example, be an initial user interface displayed when a user initiates content driven design generation process (e.g. at 602 above).

User interface 700 includes a media item selection region 702. Media item selection region 702 includes a plurality media item thumbnails 706. In this case five thumbnails are shown: 706A, 706B, 706C, 706D, and 706E (partially off screen). Thumbnails 706 represent media items which may, for example, be stored in a local memory of user system 110 (e.g. local data store 118).

A user can select a particular thumbnail 706 (e.g. by tapping or other input). In the present example, selection of a thumbnail causes a further user interface to be displayed, such as interface 800 described below.

In user interface 700 user can also cause further thumbnails 706 to be displayed, for example by a right-to-left or left-to-right swiping gesture in the media item selection region 702 and/or activation of an alternative control (not shown).

User interface 700 also includes an example layout section 710, which depicts example templates 712. In this case three example templates are displayed: 712A (which includes a single placeholder element), 712B (which includes two placeholder elements), and 712C (partially off-screen, which includes three placeholder elements).

FIG. 8 depicts a further user interface 800. In this particular example, module 116 displays interface 800 on receiving selection of a user media item (or thumbnail 706 corresponding thereto) in interface 700—for example at 604 of process 600.

User interface 800 also includes a media item selection region 802.

Media item selection region 802 includes a location indicator and selection control 804. Location indicator indicates a currently selected location (e.g. a folder or album) from which media items displayed in the media item selection region 802 are displayed. The location indicator and selection control 804 can be activated to change currently selected location (e.g. by a tap input or the like).

The location may defaults to a predefined location, for example a recent photos album or other location.

Media item selection region 802 also includes a plurality of media item thumbnails 706: 706A, 706B, 706C, 706D, 706E, 706F, 706G (partially off screen), 706H (partially off screen), and 7061 (partially off screen). In this particular example, thumbnails 706A to 706E are the same thumbnails as displayed in media item selection region 702 of user interface 700. Furthermore, thumbnail 706B is displayed with a selected media item indicator, in this case the numeral ‘1’ indicating it was the first media item selected (having being selected by a user in user interface 700).

Media item thumbnails in selection region 802 can be selected by user input—e.g. a tap user input or the like on a screen position corresponding to the thumbnail.

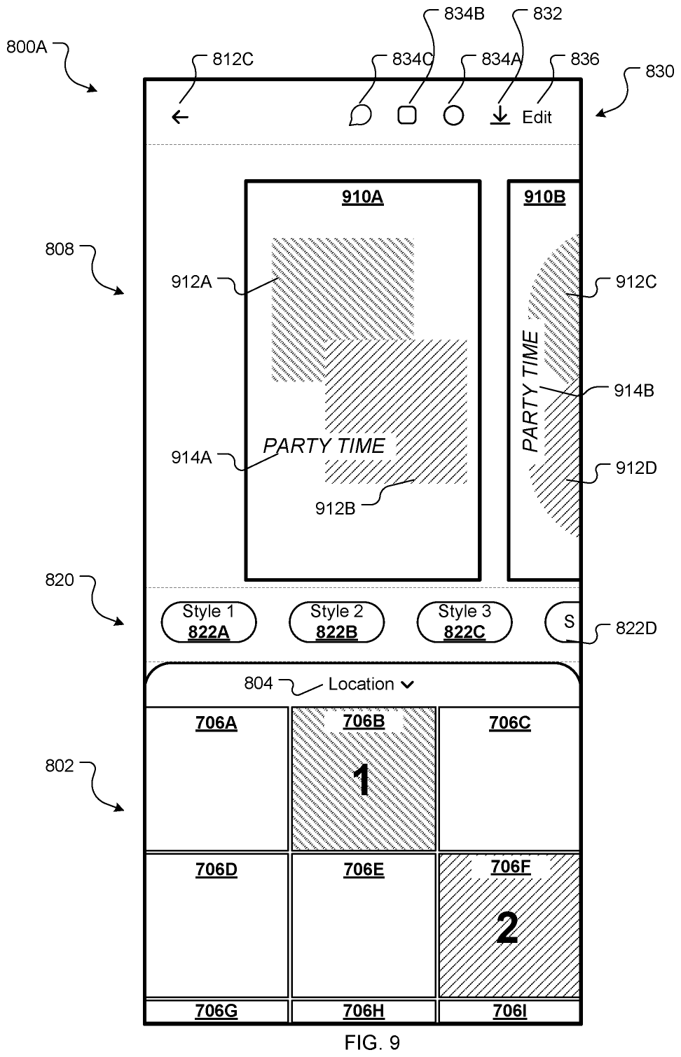

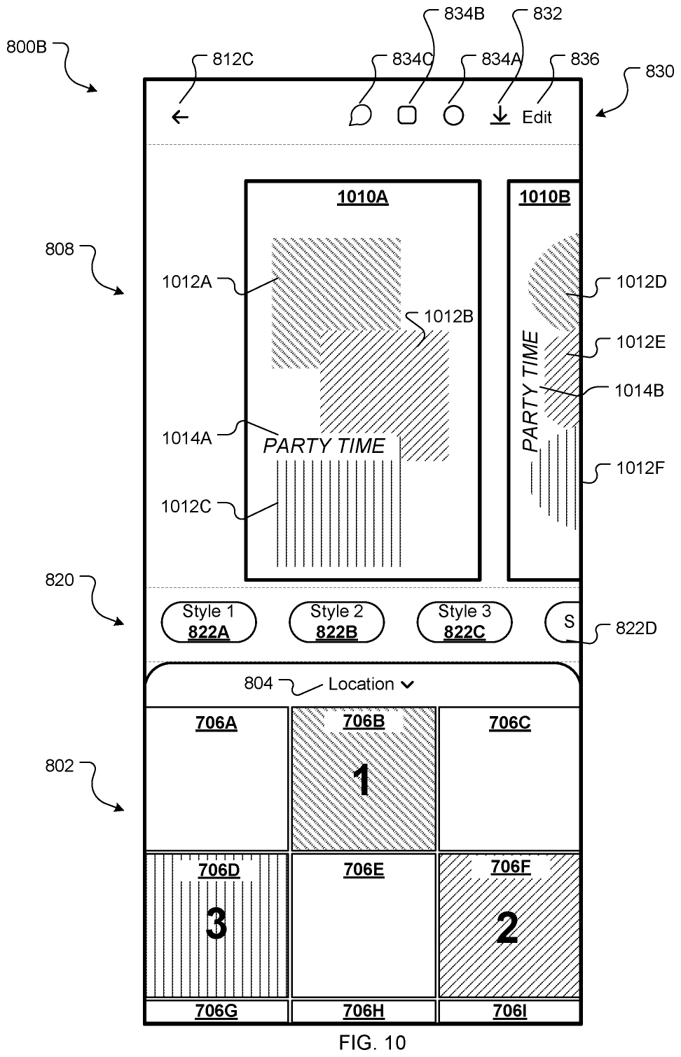

In the present example, selection of a thumbnail causes a selected media item indicator to be displayed with (e.g. atop) the selected thumbnail. Any appropriate selected media item indicator may be used, for example a tick, a dot, or any other graphic. In the present example, numbers are used as selected media item indicators in order to indicate both that a thumbnail has been selected and the order in which thumbnails are selected. For example, a first selected thumbnail (e.g. 706B) is associated with the number ‘1’, a second selected thumbnail with the number ‘2’ (see, for example, thumbnail 706F in FIG. 9), a third selected thumbnail with the number ‘3’ (see, for example, thumbnail 706D in FIG. 10) and so forth.

As discussed above, selection of an already selected thumbnail 706 causes the media item represented by the thumbnail to be deselected. Where selected media item indicators are displayed, deselection of a thumbnail causes removal of the selected media item indicator from the deselected thumbnail. Furthermore, where selected media item indicators indicate selection order, deselection may cause selected media item indicators of other selected media items to be updated. For example, if 4 thumbnails were selected and displayed with media item indicators 1, 2, 3, and 4 respectively (according to the order in which they were selected), deselection of the 2nd selected thumbnail may cause the third selected thumbnail media item indicator to update to ‘2’ and the fourth selected thumbnail media item indicator to update to ‘3’.

Media item selection region 802 can receive input (e.g. a swiping/scrolling input atop displayed thumbnails) to cause scrolling through thumbnails from selected folder/album.

Media item selection region 802 can also receive input to display a full-screen thumbnail selection interface. E.g. by swiping up on the region in which the location indicator and selection control 804 is displayed or by an alternative control.

User interface 800 also includes a design display region 808.

Design display region 808 displays one or more designs. The displayed designs may be displayed, for example, at 610 of process 600. In FIG. 8, a completely visible design 810A and a partially visible design 810B are displayed.

Each design 810 corresponds to a template bundle and includes user selected media items.

In user interface 800, a single media item has been selected by the user (corresponding to thumbnail 706B). Accordingly, designs 810 displayed are based on template bundles that define a single placeholder element 812.

In this particular example, the template bundle on which design 810A is based defines a square placeholder element 812A. Placeholder element 812A is populated by the media item corresponding to selected thumbnail 706B. Similarly, the template bundle on which design 810B is based defines a circular placeholder element 812B. Placeholder element 812B is also populated by the media item corresponding to selected thumbnail 706B.

In this example, the template bundles on which designs 810A and 810B are based each include an additional template element 814 (in this case both comprising a text element with the text ‘PARTY TIME’).

To further illustrate media item selection and design display, FIG. 9 depicts user interface 800A: a version of user interface 800 of FIG. 8 that is displayed following user selection of a second thumbnail 706F.

In FIG. 9, selection of thumbnail 706F has caused it to be displayed with media item indicator ‘2’, indicating it was the second thumbnail selected.

Furthermore, new designs 910A and 910B are displayed in design display region 808. New designs 910A and 910B are based on template bundles that include element placeholders for two media items. Design 910A includes overlapping square placeholder elements 912A and 912B (as well as template element 914A). Placeholder elements 912A and 912B are populated with user selected media items corresponding to selected thumbnails 706B and 706F. Design 910B includes overlapping circular placeholder elements 912C and 912D (and template element 914B). Placeholder elements 912C and 912D are also populated with user selected media items corresponding to selected thumbnails 706B and 706F.

FIG. 10 depicts a further user interface 800B: a version of user interface 800 of FIG. 8 that is displayed following user selection of a third thumbnail 706D.

In FIG. 10, selection of thumbnail 706D has caused it to be displayed with media item indicator ‘3’, indicating it was the third thumbnail selected.

Furthermore, new designs 1010A and 10106 are displayed in design display region 808. New designs 1010A and 10106 are based on template bundles that include element placeholders for three media items. For each design 1010A and 10106: one placeholder element (1012A and 1012D respectively) is populated with user selected media item corresponding to selected thumbnail 706B, another placeholder element (1012B and 1012E respectively) is populated with user selected media item corresponding to selected thumbnail 706F; and another placeholder element (1012C and 1012F respectively) is populated with user selected media item corresponding to selected thumbnail 706D.

A user can interact with user interface 800 to display additional designs 810, as rendered from corresponding template bundles and the selected media item(s). To do so a user can, for example, swipe/scroll through the displayed designs 810 (e.g. by a right-to-left or left-to-right swiping gesture in the design display region 808/across the displayed designs 810) and/or activation of an alternative control (not shown).

A user can also select a particular design 810, for example by tapping on the design 810. In response to detecting selection of a design 810 a full screen version of that design may be displayed.

In the present example, user interface 800 also includes a style selection region 820. Style selection region 820 includes style selection controls 822. In this example four style selection controls are displayed: 822A, 822B, 822C, and 822D (partially off screen).

A given style selection control 822 can be selected by a user (e.g. via a tap gesture) to choose a particular template style. For example, templates may be arranged into style groups to allow a user view designs based on templates of a particular style (e.g. a ‘black and white’ style, a ‘polaroid’ style’, a ‘paper’ style and/or any other template styles).

Selection of a particular style selection control 822 causes different designs 810 to be displayed in design display region 808 (each design 810 based on a template bundle of the selected style and including selected media item(s)).

Additional style selection controls 822 may be displayed, for example by a swiping/scrolling gesture (e.g. a right-to-left or left-to-right swiping gesture in the style selection region 820) and/or activation of an alternative control (not shown).

In the present example, user interface 800 also includes a control region 830. Controls displayed in the control region can be activated by user input, e.g. a tap or other user input on the relevant control.

Control region 830 of the present example includes a save control 832. Activation of the save control 832 causes module 116 to save the currently selected design (for example as described at 630-634 of process 600). The currently selected design may be a design actively selected by a user or the design that is wholly displayed in the design display region 808—e.g. design 810A). The design may be automatically saved to a local memory of the client device, for example in the folder/album currently selected by the location indicator and selection control 804. Alternatively, activation of the save control 832 may cause a save interface to be displayed allowing a user to select a particular save location, which may be local or remote.

Control region 830 of the present example includes one or more publish controls 834. In this example three separate publish controls are depicted (834A, 834B, 834C), each publish control 834 corresponding to a different publication endpoint. By way of example: publication control 834A may correspond to a social media publication endpoint such as Facebook®; publication control 834B may correspond to an image sharing publication endpoint such as Instagram®; publication control 834C may correspond to a blogging publication endpoint such as Twitter®. Alternative publication endpoints are possible.

On detecting activation of a publish control 834, module 116 causes the currently selected design to be published to the publication endpoint corresponding to the selected publish control 834. The specific operations performed to publish the design to the selected endpoint will depend on the endpoint in question. For example, in some instances module 116 may publish the design without further input (converting the design to a particular format if required, and accessing any required user credentials for publishing to the endpoint from pre-stored data). In other instances the module 116 may display one or more further user interface(s) to guide the user through the publication process.

In alternative embodiments, rather than displaying a separate publication control 834 for each endpoint in control region 830, a single publication control may be displayed which, on activation, causes a further publication user interface to be displayed, the further publication interface including different publication endpoint options.

Control region 830 of the present example includes an edit control 836. On detecting activation of the edit control 836, module 116 displays the selected design in an editing interface (not shown) via which the user can edit the design in a normal fashion—for example as described at 640 to 644 of process 600. The editing interface may include (or provide access to) editing controls that allow the user to, for example: add new design elements (e.g. shapes, pictures, videos, text, or other design elements); delete existing design elements; and/or modify design elements. Various tools for modifying existing design elements may be provided, for example tools to: reposition elements; resize elements; rotate elements; change, crop, and/or reposition media items in placeholder element; re-colour elements; altering font style (for text elements); alter element opacity; alter element depth order; and/or any other modification tools.

Control region 830 of the present example includes a back control 838. On detecting activation of the edit control 836, module 116 causes a create new design interface to be displayed (e.g. such as interface 700 described above).

As can be seen, example user interfaces described provide a mechanism for users to create a complete design by selecting media items. Furthermore, by using the template bundles as described, multiple designs that make use of user selected media items can be efficiently rendered, allowing a user to quickly and easily view them to select a particular one.

Additional, specific embodiments of the present disclosure are described in the following clauses.

Clause 1. A computer implemented method for generating a template bundle, the method including:
accessing a complete template descriptor defining a plurality of complete template elements, each complete template element associated with a complete template element media item;
processing each complete template element by, for a given complete template element:
   processing the given complete template element to generate a template bundle media item that corresponds to the complete template element media item that is associated with the given complete template element;
   saving the template bundle media item to the template bundle;
   generating a template bundle element descriptor, the template bundle element descriptor including a reference to the template bundle media item; and
   writing the template bundle element descriptor to a template bundle descriptor, the template bundle descriptor forming part of the template bundle.

Clause 2. The computer implemented method of clause 1, wherein processing the given complete template element to generate the template bundle media item includes:
determining a format of the complete template element media item that is associated with the given complete template element; and
in response to determining that the complete template element media item is a vector format media item, processing the complete template element media item to generate a corresponding raster format template bundle media item.

Clause 3. The computer implemented method of clause 2, wherein the vector format complete template media item is an in-line media item defined within a complete template element descriptor of the given complete template element.

Clause 4. The computer implemented method of clause 2, wherein:
the vector format complete template media item is a referenced media item; and
the method further includes retrieving the vector format complete template media item from a location defined by the given complete template element.

Clause 5. The computer implemented method of clause 1, wherein processing the given complete template element to generate the template bundle media item includes:
determining a format of the complete template element media item that is associated with the given complete template element; and
in response to determining that the complete template element media item is not a vector format media item:
   retrieving the complete template element media item from a location defined by an element descriptor of the given complete template element; and
   saving a copy of the complete template element media item as the corresponding template bundle media item.

Clause 6. The computer implemented method of any one of clauses 1 to 5, further including:
generating a template bundle version of the complete template descriptor; and
writing the template bundle version of the complete template descriptor to the template bundle descriptor.

Clause 7. The computer implemented method of clause 6, wherein generating the template bundle version of the complete template descriptor includes encoding the complete template descriptor.

Clause 8. The computer implemented method of any one of clauses 1 to 7, wherein processing a particular complete template element includes:
determining if the particular complete template element is a member of an element group; and
in response to determining that the particular complete template element is a member of an element group, combining the element group by:
   generating a single template bundle media item corresponding to all complete template elements that are members of the element group;
   saving the single template bundle media item to the template bundle;
   generating a single template bundle element descriptor, the single template bundle element descriptor including a reference to the single corresponding template bundle media item; and
   writing the single template bundle element descriptor to the template bundle descriptor.

Clause 9. The computer implemented method of clause 8, wherein:
in response to determining that the particular complete template element is a member of an element group, the method further includes determining if the element group can be combined; and combining the element group is performed in response to determining that the element group can be combined.

Clause 10. The computer implemented method of any one of clauses 1 to 9, further including communicating the template bundle to one or more user devices.

Clause 11. A computer processing system comprising:
a processing unit; and
non-transitory computer-readable storage medium storing sequences of instructions, which when executed by the processing unit, cause the processing unit to perform a method according to any one of clauses 1 to 10.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method including:
detecting an item selection user input, the item selection user input selecting a particular media item;
in response to detecting the item selection user input:
selecting one or more template bundles, each template bundle including:
a template bundle descriptor defining one or more non-placeholder elements and one or more placeholder elements; and
one or more template bundle media items, each template bundle media item corresponding to a non-placeholder element defined by the template bundle descriptor;
generating one or more designs, each design corresponding to a template bundle, wherein generating a particular design corresponding to a particular template bundle includes:
for each non-placeholder element defined by the template bundle descriptor of the particular template bundle, rendering the template bundle media item corresponding to the non-placeholder element; and
for each placeholder element defined by the template bundle descriptor of the particular template bundle, rendering a user selected media item, at least one of the user selected media items rendered being the particular media item; and
displaying at least one of the one or more designs on a display.

2. The computer implemented method of claim 1, wherein selecting one or more of template bundles includes:
determining a number of user selected media items that have been selected by a user; and
selecting one or more template bundles having template bundle descriptors that define a number of placeholder elements that is equal to the number of user selected media items.

3. The computer implemented method of claim 1, wherein
the user input is a first item selection input selecting a first media item; and
selecting one or more template bundles includes selecting one or more template bundles having template bundle descriptors that define a single placeholder element.

4. The computer implemented method of claim 1, wherein the user input is a further item selection input selecting a further media item and the method further includes:
determining a number of currently selected media items;
selecting one or more template bundles having template bundle descriptors that define a number of placeholder elements that is equal to the number of currently selected media items.

5. The computer implemented method of claim 1, wherein the user input is an item deselection input deselecting a currently selected media item and the method further includes:
determining a number of currently selected media items;
selecting one or more template bundles having template bundle descriptors that define a number of placeholder elements that is equal to the number of currently selected media items.

6. The computer implemented method of claim 4, further including:
determining if the number of currently selected media items exceeds a defined maximum number; and
in response to determining that the number of currently selected media items exceeds the defined maximum number, ignoring the user input.

7. The computer implemented method of claim 1, further including:
detecting an edit design user input in respect of a specific design corresponding to a specific template bundle;
in response to detecting the edit design user input:
retrieving a template bundle version of a complete template descriptor from the template bundle descriptor of the specific template bundle; and
generating a version of the specific design based on the template bundle version of the complete template descriptor.

8. The computer implemented method of claim 7, wherein generating the version of the specific design based on the template bundle version of the complete template includes replacing any placeholder elements defined by the template bundle version of the complete template with user selected media items.

9. The computer implemented method of claim 1, wherein the one or more template bundles are stored on a local data store.

10. The computer implemented method of claim 1, wherein a given template bundle of the one or more template bundles is generated by:
accessing a complete template descriptor defining a plurality of complete template elements, each complete template element associated with a complete template element media item;
processing each complete template element by, for a given complete template element:
processing the given complete template element to generate a template bundle media item that corresponds to the complete template element media item that is associated with the given complete template element;
saving the template bundle media item to the given template bundle;
generating a template bundle element descriptor, the template bundle element descriptor including a reference to the template bundle media item; and
writing the template bundle element descriptor to a template bundle descriptor, the template bundle descriptor forming part of the given template bundle.

11. A computer processing system comprising:
a processing unit;
a display; and
non-transitory computer-readable storage medium storing instructions, which when executed by the processing unit, cause the processing unit to:
detect an item selection user input selecting a particular media item;
in response to detecting the item selection user input:
select one or more template bundles, each template bundle including:
a template bundle descriptor defining one or more non-placeholder elements and one or more placeholder elements; and
one or more template bundle media items, each template bundle media item corresponding to a non-placeholder element defined by the template bundle descriptor;
generate one or more designs, each design corresponding to a template bundle, wherein generating a particular design corresponding to a particular template bundle includes:
for each non-placeholder element defined by the template bundle descriptor of the particular template bundle, rendering the template bundle media item corresponding to the non-placeholder element; and
for each placeholder element defined by the template bundle descriptor of the particular template bundle, rendering a user selected media item, at least one of the user selected media items rendered being the particular media item; and
display, on the display, at least one of the one or more designs.

12. The computer processing system of claim 11, wherein selecting one or more of template bundles includes:
determining a number of user selected media items that have been selected by a user; and
selecting one or more template bundles having template bundle descriptors that define a number of placeholder elements that is equal to the number of user selected media items.

13. The computer processing system of claim 11, wherein
the user input is a first item selection input selecting a first media item; and
selecting one or more template bundles includes selecting one or more template bundles having template bundle descriptors that define a single placeholder element.

14. The computer processing system of claim 11, wherein the user input is a further item selection input selecting a further media item and the method further includes:
determining a number of currently selected media items;
selecting one or more template bundles having template bundle descriptors that define a number of placeholder elements that is equal to the number of currently selected media items.

15. The computer processing system of claim 11, wherein the user input is an item deselection input deselecting a currently selected media item and the method further includes:
determining a number of currently selected media items;
selecting one or more template bundles having template bundle descriptors that define a number of placeholder elements that is equal to the number of currently selected media items.

16. The computer processing system of claim 14, wherein when executed by the processing unit, the instructions further cause the processing unit to:
determine if the number of currently selected media items exceeds a defined maximum number; and
in response to determining that the number of currently selected media items exceeds the defined maximum number, ignore the user input.

17. The computer processing system of claim 11, wherein when executed by the processing unit, the instructions further cause the processing unit to:
detect an edit design user input in respect of a specific design corresponding to a specific template bundle; and
in response to detecting the edit design user input:
retrieve a template bundle version of a complete template descriptor from the template bundle descriptor of the specific template bundle; and
generate a version of the specific design based on the template bundle version of the complete template descriptor.

18. The computer processing system of claim 17, wherein generating the version of the specific design based on the template bundle version of the complete template includes replacing any placeholder elements defined by the template bundle version of the complete template with user selected media items.

19. The computer processing system of claim 11, wherein the one or more template bundles are stored on a local data store.

20. The computer processing system of claim 11, wherein a given template bundle of the one or more template bundles is generated by:
accessing a complete template descriptor defining a plurality of complete template elements, each complete template element associated with a complete template element media item;
processing each complete template element by, for a given complete template element:
processing the given complete template element to generate a template bundle media item that corresponds to the complete template element media item that is associated with the given complete template element;
saving the template bundle media item to the given template bundle;
generating a template bundle element descriptor, the template bundle element descriptor including a reference to the template bundle media item; and
writing the template bundle element descriptor to a template bundle descriptor, the template bundle descriptor forming part of the given template bundle.
